(19) United States
(12) Patent Application Publication
(10) Pub. No.: US 2005/0084649 A1
(43) Pub. Date: Apr. 21, 2005

(54) System for foot care

(76) Inventor: Angela Patlakh, Philadelphia, PA (US)

Correspondence Address: Richard C. Litman;LITMAN LAW OFFICES, LTD., P.O. BOX 15035, Arlington, VA, 22215, US

(21) Appl. No.: 10/810,892

(22) Filed: Mar. 29, 2004

Related U.S. Application Data
(60) Provisional application No. 60/464,129, filed on Apr. 21, 2003.

(51) Int. Cl. B32B 3/06

(52) U.S. Cl. 428/101; 601/136; 15/215

(57) ABSTRACT

A foot care system adapted to take care of human feet, comprising a foot mat and at least one moisturizing foot sock. The foot mat is adapted to remove dead skin cells from a sole of a foot, and the foot sock is adapted to moisturize a wearer's foot while permitting the wearer to engage in other desired activities. The foot sock have drops or balls of moisturizer, and/or at least one sachet of foot moisturizing lotion. The foot sock and foot mat can be combined to provide a kit. In one embodiment, the foot mat is adapted for vertical mounting on a sidewall, such as a bath or shower cubicle wall, or the foot mat may be supplied as an insert in a separate mat.

### CROSS-REFERENCE TO RELATED APPLICATION

This application claims the benefit of U.S. Provisional Patent Application Ser. No. 60/464,129, filed Apr. 21, 2003.

### BACKGROUND OF THE INVENTION

1. Field of the Invention

The present invention is directed to foot care in general, and more particularly to a system of skin foot care.

2. Description of the Related Art

There are several reasons why a person should take care of their feet. Cleanliness and hygiene considerations dictate that a person should keep their feet reasonably clean to prevent problems associated with foot conditions, such as athlete's foot, diabetic foot ulcers, toenail fungi, and foot odors.

The skin of the feet presents a natural barrier against ingress of bacteria and germs into the feet. To maintain the natural barrier it is particularly important that the skin covering the feet be kept in good condition. When bathing, particularly when taking a stand-up shower, it is difficult to wash one's feet thoroughly due to the need to bend, which may be physically difficult and which may increase the danger of falling.

According to the International Working Group On The Diabetic Foot, more than 150 million people in the world have diabetes mellitus, many of whom suffer from diabetic foot ulcers. A diabetic patient who develops a foot ulcer is at risk of having their foot amputated. Thus, a diabetic patient should be particularly careful to maintain the skin of their feet in good condition.

People of all generations and age groups are vulnerable to problems with their feet. The skin of the feet, particularly the sole of the feet, hardens and thickens on practically everyone, especially on persons who are on their feet a lot and on the elderly. When skin thicknesses of that kind are left uncared for, it causes a large amount of discomfort and painful skin openings that lead to an infection. Thus, there is a need to remove dead skin in order to help alleviate natural thickening of the skin on the soles of the feet.

A younger person may also experience problems with the skin of their feet. For example, relocating to a hard water area from a soft water area can lead to dryness in the skin of the soles of the feet. Water softeners linked to bath and shower outlets can help avoid this problem. Thus, there is a need to moisturize feet in a hard water area, particularly with regard to persons who reside in a residence that lacks a water softener.

People with regular jobs, busy schedules, and long commutes to work often face considerable pressures on their time, particularly when getting ready to leave their house or apartment to catch, e.g., an early morning train. A person rushing to get ready to leave for work typically has only limited time to spend on foot care. Thus, a system is needed to aid a person to moisturize and remove skin from their feet without causing an undue delay in getting ready for work.

Several efforts have been made to address these problems. U.S. Pat. No. 3,276,060, issued Oct. 4, 1966 to D. F. Stokes, Jr., describes a foot care appliance. The '060 device is overly cumbersome, large, and burdensome to use and maintain. For example, a user of the '060 device must master the mechanics of water pressure combined with temperature to operate a plurality of water-powered mechanical turbines and valves. Thus, the '060 device is very unsuitable for an elderly or very young person of limited ability or persuasion to use such a device safely. In addition, the '060 device does not offer a simple means for a user to moisturize their feet while, e.g., brushing their teeth.

U.S. Pat. No. 5,293,660, issued Mar. 15, 1994 to H. Jai Park, describes a foot scrub mat which includes a flexible base and a replaceable pad. The replaceable pad is described as having a bristle area for more efficient foot cleaning. While the '660 device is much simpler to use than the cumbersome '060 device described above, the '660 device does not provide for moisturizing the skin of the feet. Thus, there is a need for a system that both cleans and moisturizes the feet, particularly the skin associated with the soles of the feet.

U.S. Pat. No. 5,095,548, issued Mar. 17, 1992 to R. E. Chesebro, Jr., shows a moisture removal sock particularly suited to sportsmen and women, such as hikers. The '548 sock comprises both hydrophilic (water loving) and hydrophobic (water hating) yarns arranged to channel moisture away from a user's foot during heavy exertion. The yarn of the '548 sock is for all day use and is not suitable for applying, e.g., a cream moisturizer to feet. Thus, there is a need for a moisturizing sock that is not worn all day.

British Patent No. 2,366,731, published Mar. 20, 2002, describes a disposable sock made of natural latex. The '731 sock is described as useful to protect the feet following application of a medicated cream for the treatment of skin complaints, such as hyperkeratosis. The '731 socks may be dispensed from a box in the same way as disposable surgical gloves. To the extent that the '731 sock uses natural latex, the sock presents a danger to those who have either a diagnosed or an undiagnosed allergy to natural latex. More specifically, a person allergic to natural latex may develop skin rashes, hives, and display other allergic symptoms involving the nasal passages and eyes. Thus, there is a need for a moisturizing sock that does not use natural latex or a natural latex derivative.

Other patents showing devices or systems for providing foot care but which do not solve the above mentioned problems include U.S. Pat. No. 3,922,409, issued Nov. 25, 1975 to E. Stark (a foot mat); U.S. Pat. No. 4,061,268, issued Dec. 6, 1977 to R. D. DeMaster (a traction mat); U.S. Pat. No. 4,167,599, issued Sep. 11, 1979 to E. N. Kaskenkatu (one or more mats); U.S. Pat. No. 4,617,917, issued Oct. 21, 1986 to G. C. Miller (a foot hygiene device); U.S. Pat. No. 5,343,882, issued Sep. 6, 1994 to S. Iannone (a foot care kit); U.S. Pat. No. 5,560,068, issued Oct. 1, 1996 to E. Blake (a foot shower brush); U.S. Pat. No. 5,601,900, issued Feb. 11, 1997 to H. Doscher (anti-skid mat); U.S. Pat. No. 5,645,914, issued Jul. 8, 1997 to A. J. Horowitz (anti-fatigue mat); U.S. Pat. No. 6,114,002, issued Sep. 5, 2000 to B. Rinaldo (portable hygienic mat); U.S. Pat. No. 6,171,269, issued Jan. 9, 2001 to M. Norin (multi-function podiatric device); U.S. Pat. No. 6,273,906, issued Aug. 14, 2001 to J. D. Swanson (foot care device); U.S. Pat. No. 6,298,496, issued Oct. 9, 2001 to I. F. Evans (protective surgical sock); G.B. Pat. No. 2,068,210, published Aug. 12, 1981 (footwear incorporating a hygiene arrangement); and G.B. Pat. No. 2,268,401, published Jan. 1, 1994 (smelly feet prevention).

None of the above inventions and patents, taken either singly or in combination, is seen to describe the instant invention as claimed. Thus a system of foot care solving the aforementioned problems is desired.

### SUMMARY OF THE INVENTION

A foot care system adapted to take care of human feet, comprising a foot mat and at least one moisturizing foot sock. The foot mat is adapted to remove dead skin cells from a sole of a foot, and the foot sock is adapted to moisturize a wearer's foot while permitting the wearer to engage in other desired activities. The foot sock have drops or balls of moisturizer, and/or at least, one sachet of foot moisturizing lotion. The foot sock and foot mat can be combined to provide a kit. In one embodiment, the foot mat is adapted for vertical mounting on a sidewall, such as a bath or shower cubicle wall, or the foot mat may be supplied as an insert in a separate mat.

It is an object of the invention to provide a moisturizing system for moisturizing feet.

It is another object of the invention to provide a moisturizing system that moisturizes a person's feet without unduly encroaching on the ability of the person to engage in unrelated tasks.

It is still another object of the invention to provide a foot mat to remove unwanted skin cells from at least one sole of a person's feet.

It is a further object of the invention to provide a kit that can condition a person's feet without unduly interfering with the person's desire to do other things, such as getting ready for work.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a pair of moisturizing socks according to the present invention.

FIG. 2A is a vertical cross section view of a moisturizing sock according to the present invention with at least one intact sachet containing a moisturizing agent.

FIG. 2B is a vertical section view of the moisturizing sock of FIG. 2A with the moisturizing agent shown exiting the sachet.

FIG. 3A is a perspective view of a sachet containing a moisturizing agent according to the present invention.

FIG. 3B is a perspective view of the sachet of FIG. 3A with the moisturizing agent shown exiting the sachet.

FIG. 4 is an environmental, perspective view of a foot mat according to the present invention.

FIG. 5A is a top view of the foot mat of FIG. 4.

FIG. 5B is a side view of the foot mat of FIG. 4.

FIG. 5C is a top view of an alternative embodiment of a foot mat according to the present invention.

FIG. 6 is a perspective view of a foot mat according to the present invention inserted into a second foot mat.

Similar reference characters denote corresponding features consistently throughout the attached drawings.

### DETAILED DESCRIPTION OF THE PREFERRED EMBODIMENTS

The present invention is directed to a system of foot care, and is particularly directed to the care of the skin of the feet using at least one moisturizing foot sock and/or an abrasive foot mat.

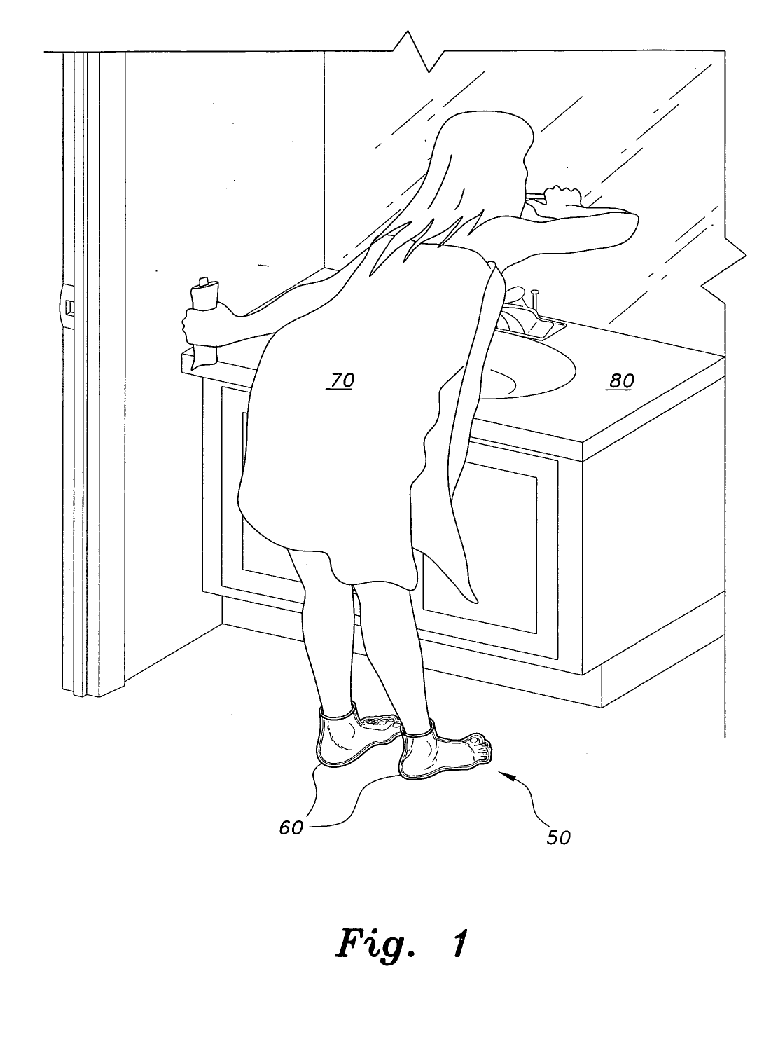

FIG. 1 shows an environmental perspective view of a moisturizing foot sock 50, or more precisely, a pair of socks 50, according to a first embodiment of the invention. The moisturizing foot socks 50 are shown on the feet 60 of a wearer 70. The wearer 70 is shown wearing one foot sock 50 per foot while brushing her teeth at a bathroom sink 80. The moisturizing socks 50 are designed to continuously provide a wearer's feet 60 with moisturizing lotion while the wearer 70 is engaging in ordinary everyday activities, such as the illustrated example of brushing teeth (as shown in FIG. 1) or attending to other personal tasks.

It is clear from FIG. 1 that a person can perform other non-related tasks when using a pair of moisturizing socks 50. Specifically, a wearer 70 has no need to use one or both hands to rub moisturizer into the soles of their feet 60. Thus, the wearer 70 can perform other tasks, such as brushing teeth, while simultaneously applying moisturizing lotion to their feet 60 using the moisturizing socks 50.

It should be understood that the wearer 70 may wear one moisturizing sock 50 on one foot. For example, the wearer 70 may require or desire just one moisturizing treatment for only one foot. However, the wearer 70 can wear a pair of moisturizing socks 50 to moisturize both feet 60 as shown in FIG. 1. The moisturizing socks 50 are preferably disposed of after use.

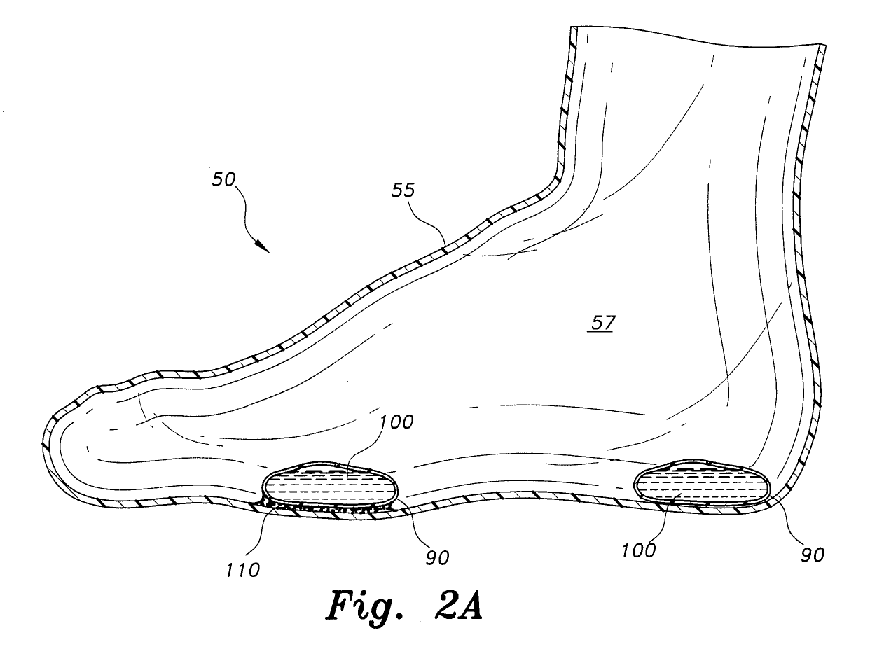

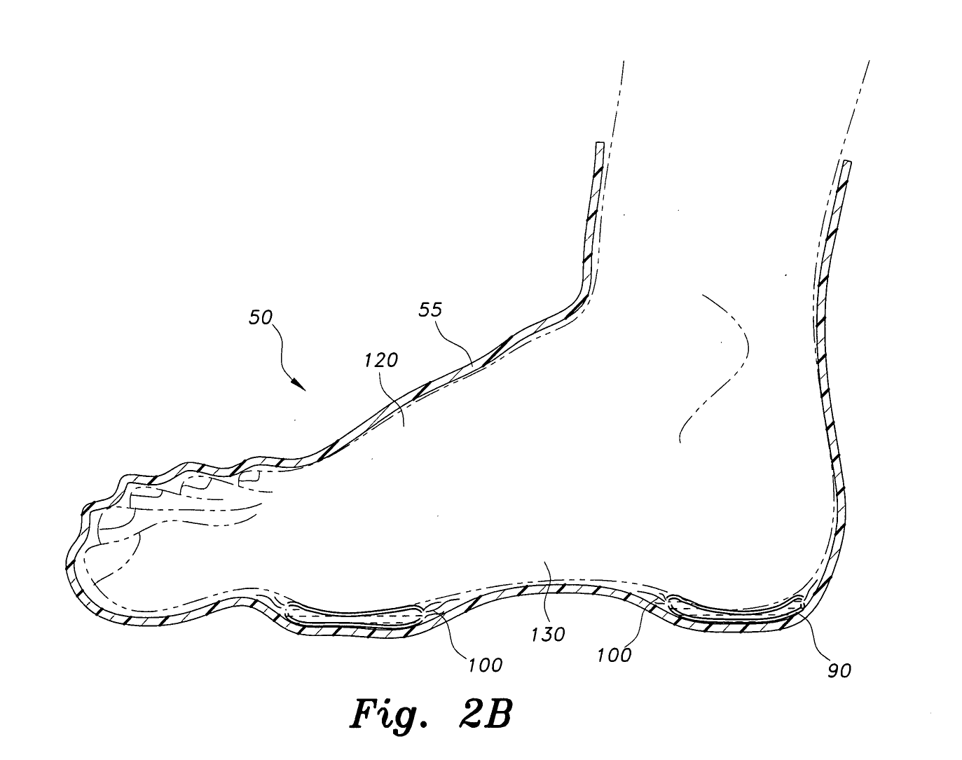

FIG. 2A shows a cross-section along the length of an empty moisturizing foot sock 50 according to one embodiment of the invention. The moisturizing foot sock 50 comprises a moisturizing sock lining 55 defining an inner sock volume 57. At least one sachet 90 is shown inside the moisturizing sock 50, and more particularly in the inner sock volume 57. The sachet 90 is shown filled with moisturizing agent 100 (e.g., any known moisturizing lotion). The sachet 90 may be free to move independently of the lining 55 or may be affixed to the lining 55 by an adhesive agent 110. The terms “moisturizing agent” and “moisturizer” are hereinafter regarded as equivalent terms. The sock lining 55 may be made out of any suitable material, such as clear plastic polyethylene, polypropylene, vinyl (more particularly, PVC or polyvinyl chloride); polyethylene is very flexible and is the preferred material for the lining 55. Alternatively, the lining 55 may be made from a 3-ply tissue.

It should be understood that the term “effective amount of moisturizing agent” means a sufficient amount of the moisturizing agent present in a moisturizing sock 50 to moisturize a wearer's foot 120, and more particularly the sole 130. Actual amounts of moisturizing agent 100 in the moisturizing sock 50 can be varied so as to achieve the desired degree of moisturization to suit a particular wearer 70. It is well within the skill of a moisturizing sock wearer 70 to, for example, increase or decrease the number of sachets 90 according to the preference of the wearer 70, or to select a sock 50 having a desired number o9f sachets 90 therein to achieve the moisturizing level desired, which may be influenced by such factors as the wearer's actual feeling of dryness and condition of the wearer's sole 130.

It should also be understood that a wearer 70 may also, for example, add drops of moisturizing agent in place of, or in addition to, the sachet 90. For example, drops of Inves^{t} moisturizing lotion may be added to the socks 50. The moisturizing drops may be dispensed from a separate container and added to the moisturizing socks 50. Alternatively balls or gels of moisturizing agent may be added to the moisturizing socks 50 in place of, or in addition to, the moisturizing sachet 90 to achieve the desired degree of moisturization of a sole 130 (see FIG. 2B) of a wearer's foot 120.

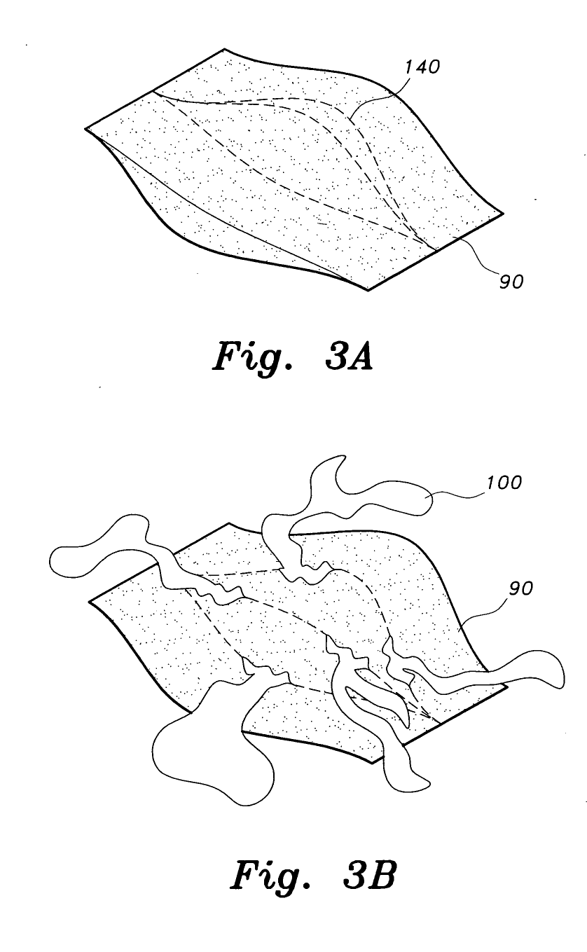

Referring to FIGS. 2B, 3A, and 3B generally, and FIG. 2B in particular, FIG. 2B shows a wearer's foot 120 inside the moisturizing sock 50 of FIG. 2A. The foot 120 has crushed or caused the sachet 90 to burst, releasing the moisturizing agent 100. FIGS. 3A and 3B show the sachet both intact and during release of the moisturizer 100, respectively. The moisturizing agent 100 is thence free to moisturize the foot 120, and in particular the sole 130 of the foot 120. The sachet 90 preferably comprises a weakness in the form of an indentations 140, as indicated in FIG. 3A, which pulls apart upon application of pressure, causing the sachet 90 to split and thence release the moisturizing agent 100, as shown in FIG. 3B. The source of the pressure is normally provided by the weight of a wearer's foot 120 acting against the sachet 90, and more specifically the pressure of the wearer's sole 130 against the sachet 90.

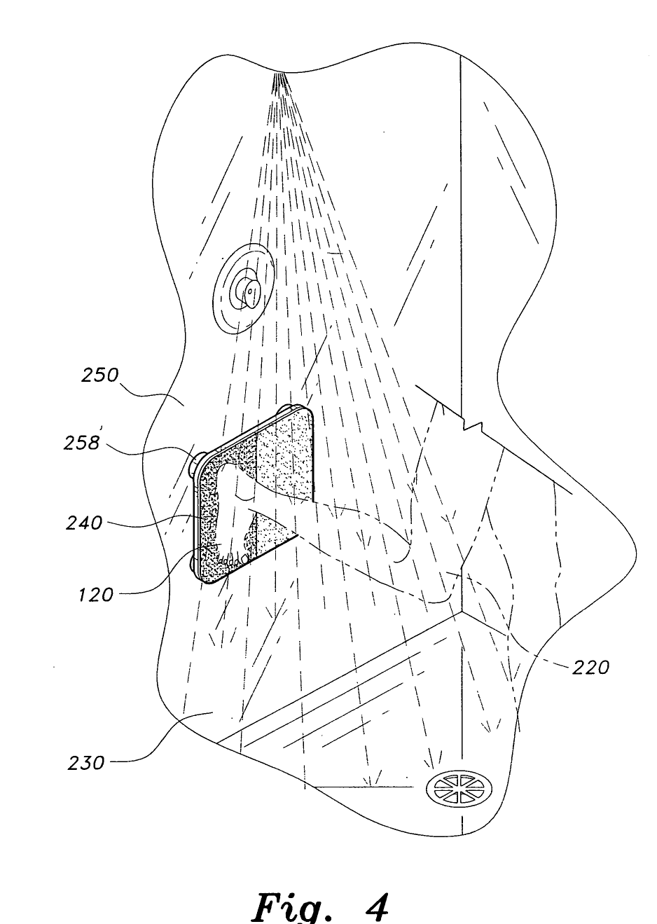

FIG. 4 shows a person 220 in a shower 230 with a foot 120 rubbing against a vertically mounted foot mat 240. The foot mat 240 is held against a wall 250 by means of at least one suction cup 258 connected to the base 280 of the foot mat 240.

It should be understood that the moisturizing sock 50 and foot mat 240 can be combined in order to provide a foot care kit. The foot care kit is used to condition a person's feet 60.

The kit comprises a foot mat 240 for removing dead skin cells from the sole of at least one of a person's feet 60, and at least one moisturizing foot sock 50 for moisturizing the sole of at least one of a wearer's feet 60, freeing the wearer 70 to engage in unrelated activities, such as brushing teeth or combing hair.

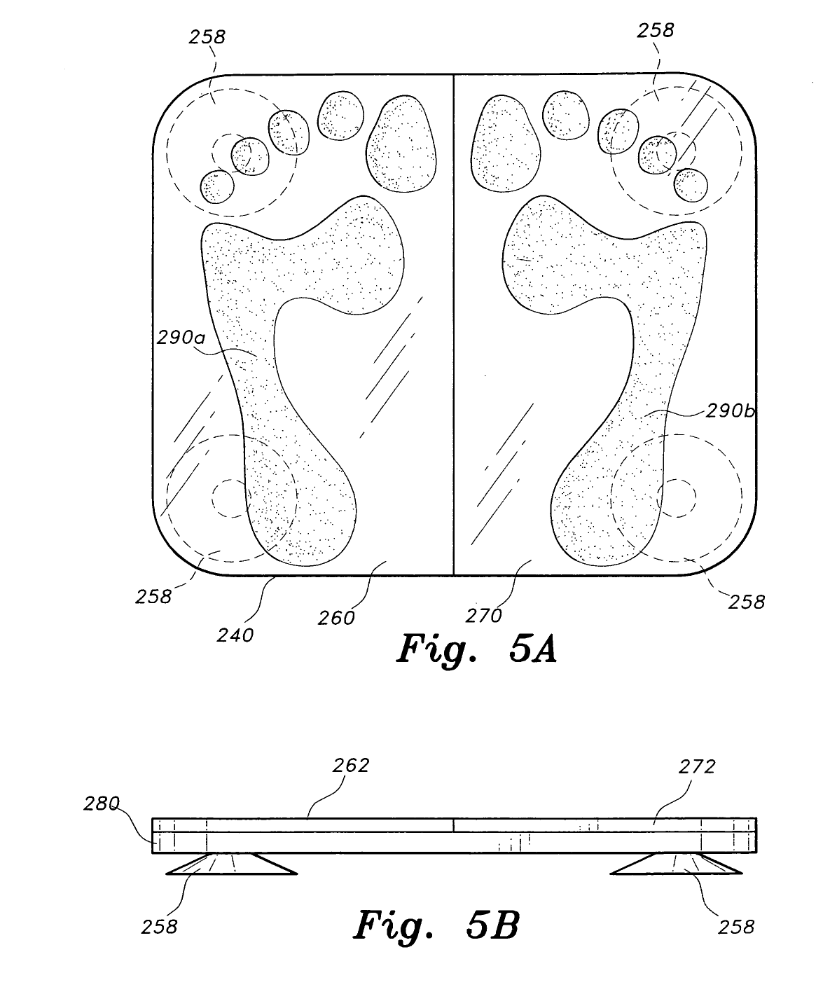

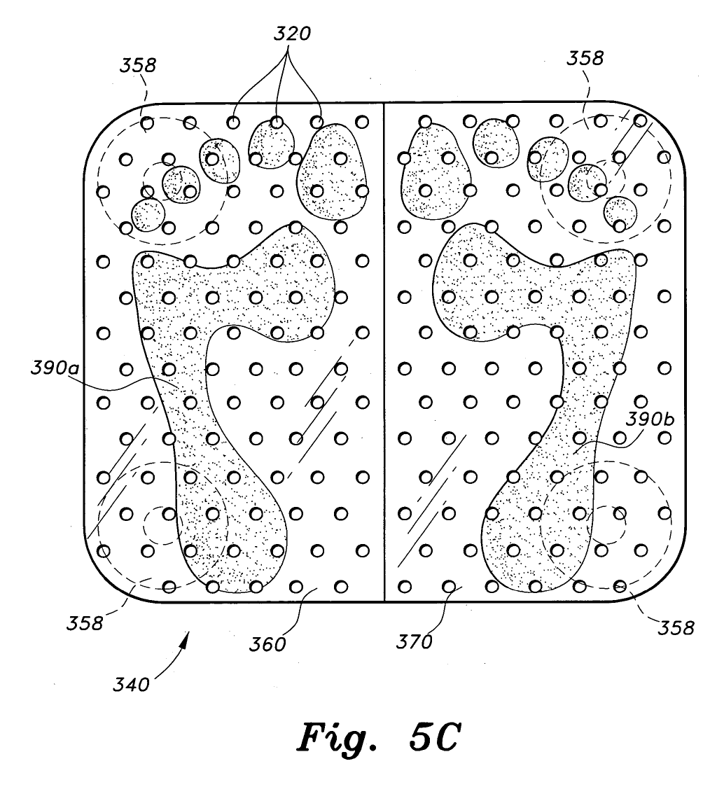

FIGS. 5A and 5B show a top and side view respectively of the foot mat 240. The foot mat 240 comprises two surfaces of differing roughness. However, the foot mat 240 could also be made to possess one surface having a uniform roughness. A first surface 260 and a second surface 270 are shown; each of the surfaces 260 and 270, respectively, comprise a layer of abrasive material 262 and 272 adapted to remove skin cells, preferably dead skin cells, from the sole 130 of a foot 120. This is achieved by rubbing the sole 130 against the first 260 or second 270 abrasive surfaces of the foot mat 240. The layers 262 and 272 are attached to a base 280 as shown in FIG. 5B, which shows a side view of the foot mat 240. Each surface 260 and 270 may comprise an optional complementary pair of indentations 290a and 290b that simulate the shape and contours of the soles 130 of feet 120. The base 280 may be made from any suitable material including recycled material such as recycled rubber. In a preferred embodiment each surface 260 and 270 may be varied by replacing, separately or together, the layers 262 and 272; for example, a user may desire a different surface for rubbing against one foot and so could replace the layer 262 with a new layer of more or less abrasive material in accordance with the desire of the user 220. The surfaces 260 and 270 may comprise of such non-limiting materials as, for example, a layer of bean strip, emery cloth or light sand paper.

FIG. 5C shows an alternative embodiment of a foot mat 340 according to the present invention. Foot mat 340 includes at least two surfaces 360, 370 having differing roughness, or one surface of uniform roughness. The surfaces 360, 370 may be replaceable, either separately or together. A plurality of drain holes 320 perforate the foot mat 340, permitting water to drain through the holes and provide a more hygienic foot mat. Like foot mat 240, optional indentations 390a and 390b that simulate the shape and contours of the soles 130 of the feet 120 may be disposed on the foot mat 340.

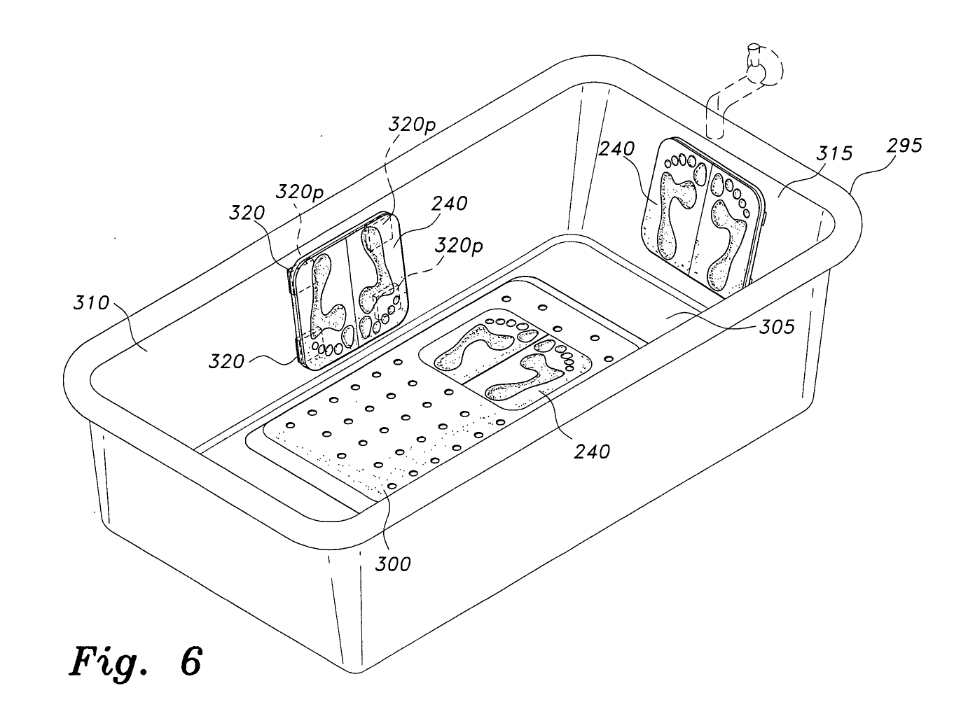

FIG. 6 shows a bath tub 295 with a second foot mat 300 attached to the base 305 of the tub 295. The foot mat 240 is shown inserted into the second foot mat 300; it should be understood that in the context of FIG. 6 that the terms “foot mat 240” and “first foot mat 240” should be regarded as equivalent terms. When desired the first foot mat 240 can be pulled out of the foot mat 300 and replaced with a fresh first foot mat 240. The first foot mat 240 is also shown stuck to a side 310 of the bath tub 295 using at least one suction cup 258 or any suitable attachment device, such as at least one adhesive patch 320 (shown, in part, using a phantom line 320p). The first foot mat 240 may also be attached to at least one end 315 of the tub 295, thereby allowing a person to remove skin cells from their feet while sitting or lying back in the bath tub 295.

It is to be understood that the present invention is not limited to the embodiments described above, but encompasses any and all embodiments within the scope of the following claims.

1. A foot care kit to condition a person's feet, comprising:
a first foot mat adapted to remove dead skin cells from a sole of the person's foot;
a second foot mat, the first foot mat being removably disposed on the second foot mat, whereby the first feet mat is replaceable in order to keep the first foot pad fresh; and
at least one foot sock for moisturizing the person's foot, thereby freeing the person to engage in other desired activities.

2. The foot care kit of claim 1, wherein the foot care kit comprises recycled materials.

3. The foot care kit of claim 1, wherein the at least one sock further comprises at least one sachet of foot moisturizing lotion disposed within the sock, the sachet being frangible in order to release the lotion in response to firm pressure applied by the sole of the person's foot.

4. The foot care kit of claim 1, wherein the foot mat is adapted for attachment to a vertical surface.

5. The foot care kit of claim 1, wherein the first foot mat further comprises at least one suction cup adapted for attaching the foot mat to a vertical surface.

6. The foot care kit of claim 1, wherein the first foot mat further comprises a layer of adhesive material disposed on a bottom surface of the mat for attaching the first foot mat to a vertical surface.

7. The foot care kit of claim 1, wherein the first foot mat has a plurality of drain holes defined therein.

8. The foot care kit of claim 1, wherein the first foot mat has at least one abrasive surface.

9. A foot care kit to condition a person's feet, comprising:
a first foot mat having at least one abrasive top surface for removing dead skin cells from a sole of the person's foot and having a bottom surface;
at least one foot sock having at least one frangible sachet disposed within the sock; and
a moisturizing lotion disposed within the sachet, whereby the person abrades dead skin cells from the sole of the person's foot by abrading the cells on the foot mat, and moisturizes the foot by donning the sock and releasing the moisturizing lotion from the sachet.

10. The foot care kit according to claim 9, wherein said abrasive top surface comprises a layer of abrasive material selected from the group consisting of bean strip, emery cloth, and sand paper.

11. The foot care kit according to claim 9, wherein said at least one abrasive top surface comprises two adjacent abrasive surfaces having different degrees of abrasiveness.

12. The foot care kit according to claim 9, wherein said first foot mat has a plurality of perforations defined therein forming drain holes.

13. The foot care kit according to claim 9, further comprising a plurality of suction cups attached to the bottom surface of said first foot mat.

14. The foot care kit according to claim 9, further comprising a layer of adhesive disposed on the bottom surface of said first foot mat.

15. The foot care kit according to claim 9, further comprising a second foot mat, the first foot mat being removably disposed on the second foot mat.

16. The foot care kit according to claim 9, wherein the top surface of said first foot mat has an imprint of a foot defined therein.

17. The foot care kit according to claim 9, wherein said at least one foot sock comprises a pair of foot socks.

18. The foot care kit according to claim 9, wherein said at least one sachet comprises a plurality of sachets.

19. A foot sock for moisturizing a foot of a wearer of the sock, comprising:
a substantially cylindrical, tubular fabric having a closed end and an open end defining foot sock;
at least one frangible sachet disposed within the foot sock; and
a moisturizing lotion disposed within the sachet, whereby the wearer moisturizes the foot by donning the sock and releasing the moisturizing lotion from the sachet by applying pressure to the sachet.
